(19) United States
(12) Patent Application Publication
(10) Pub. No.: US 2016/0006709 A1
(43) Pub. Date: Jan. 7, 2016

(54) SYSTEM AND CONTROL METHOD THEREOF

(71) Applicant: CANON KABUSHIKI KAISHA, Tokyo (JP)

(72) Inventor: Yuka Sakurai, Yokohama-shi (JP)

(21) Appl. No.: 14/792,281

(22) Filed: Jul. 6, 2015

(30) Foreign Application Priority Data
Jul. 7, 2014 (JP) 2014-139963

(51) Int. Cl. H04L 29/06

(52) U.S. Cl. CPC H04L 63/06; H04L 63/08

(57) ABSTRACT

A system for monitoring a device includes issuing an authentication key, establishing a connection between a management apparatus and a monitoring apparatus using the authentication key, cancelling a task for monitoring the device and acquiring operational information from the device according to a transfer related input, transmitting task information relating to the cancelled task and the acquired operational information to the management apparatus, transmitting a transfer instruction to the management apparatus, invalidating the authentication key according to the transfer instruction, requesting, based on the transfer related input, to newly register a monitoring apparatus with reference to identification information associated with a different monitoring apparatus, and issuing, in response to the request and based on the identification information associated with the monitoring apparatus, a new authentication key.

### BACKGROUND

1. Field

Aspects of the present invention generally relate to a technique for monitoring a device.

2. Description of the Related Art

It is conventionally known that a device management system is available to analyze operational information and counter information collected from a target device represented by an image forming apparatus (e.g., a multifunction peripheral). The device management system can be configured to include a monitoring apparatus capable of collecting device information and a management apparatus capable of managing the information collected by the monitoring apparatus. In general, for security reasons, an authentication key is used in communications performed between the monitoring apparatus and the management apparatus.

When a customer starts using a monitoring apparatus, it is not expected to use the same monitoring apparatus permanently. In many instances, the monitoring apparatus is replaced by a new monitoring apparatus at certain times due to various reasons (e.g., breakdown of the monitoring apparatus, newer version of the monitoring apparatus, etc.), where information from the monitoring apparatus being replaced needs to be transferred to the new monitoring apparatus. The new monitoring apparatus is required to continue collecting device information, etc. without causing any disruptions after changing monitoring apparatuses.

However, for an administrator who handles replacing monitoring apparatuses, performing settings for the replaced monitoring apparatus and the management apparatus again after the change is a big burden.

In performing communications between the monitoring apparatus and the management apparatus, license information is required. Typically, for convenience and security reasons, license information issued for each monitoring apparatus is included in an installer of software that provides the function of the monitoring apparatus.

In this case, because each monitoring apparatus is associated with an installer, if replacement of the monitoring apparatus occurs, the new monitoring apparatus is recognized as another monitoring apparatus. Accordingly, it is necessary to re-perform initial settings for the monitoring apparatus and the management apparatus. Thus, the burden of the administrator increases significantly.

In recent years, the monitoring apparatus has needed to support a multi-vendor device. To do so, the monitoring apparatus needs to run not only basic software, but also any additional specialized software associated with particular vendors. In this case, ensuring that both any basic and any specialized software is loaded onto a replacement monitoring apparatus falls to the administrator, increasing the administrator's burden even more.

### SUMMARY

According to an aspect of the present invention, in a system including a management system and a monitoring apparatus that is connectable to the management system via a network and can monitor a device in a customer environment, a first information processing apparatus that is operating as the monitoring apparatus includes a connection unit configured to perform a connection with the management system, using an authentication key issued by the management system, a control unit configured to control cancellation of a task for monitoring the device and acquisition of operational information from the device according to a transfer related input by a user, a first transmission unit configured to transmit task information relating to the cancelled task and the acquired operational information to the management system using the connection by the connection unit, and a second transmission unit configured to transmit a transfer instruction to the management system, using the connection by the connection unit, after the transmission by the first transmission unit, the management system includes an issuance unit configured to issue the authentication key to be used to establish the connection to the monitoring apparatus, a management unit configured to manage the authentication key, identification information about the monitoring apparatus for which the authentication key has been issued, and customer information relating to the customer environment in which the monitoring apparatus is installed while associating the information to be managed with each other, a reception unit configured to receive the task information and the operational information from the first information processing apparatus, and an invalidation unit configured to invalidate the authentication key managed by the management unit and used in the connection to the first information processing apparatus according to the transfer instruction from the first information processing apparatus, and wherein the management system is further connectable to a second information processing apparatus that is operable as the monitoring apparatus via the network, and wherein the issuance unit is configured to issue a new authentication key, which is different from the authentication key issued for the first information processing apparatus, for the second information processing apparatus, in response to a request from the second information processing apparatus based on the identification information about the monitoring apparatus having served as the first information processing apparatus such that the second information processing apparatus is newly registered as a monitoring apparatus.

Further features of the present disclosure will become apparent from the following description of exemplary embodiments with reference to the attached drawings.

### BRIEF DESCRIPTION OF THE DRAWINGS

FIG. 1 illustrates an example of the entire configuration of a system according to an exemplary embodiment.

FIG. 2 illustrates a hardware configuration of a management apparatus and a monitoring apparatus.

FIG. 3 illustrates a hardware configuration of a device.

FIG. 4 illustrates a software configuration of the management apparatus.

FIG. 5 illustrates a software configuration of the monitoring apparatus.

FIG. 6 illustrates a device list that is managed by the management apparatus.

FIG. 7 illustrates a monitoring apparatus management table that is managed by the management apparatus.

FIG. 8 illustrates a device list for each service that is managed by the monitoring apparatus.

FIG. 9 illustrates a service function management list that is managed by the monitoring apparatus.

FIG. 10 is a flowchart illustrating an operation of the management apparatus in monitoring apparatus transfer processing.

FIG. 11 is a flowchart illustrating an operation of the monitoring apparatus in the monitoring apparatus transfer processing.

FIG. 12 is a flowchart illustrating an operation of the management apparatus in monitoring apparatus registration processing.

FIG. 13 is a flowchart illustrating an operation of the monitoring apparatus in the monitoring apparatus registration processing.

FIG. 14 is a flowchart illustrating operations in additional software license transfer processing.

FIG. 15 illustrates an example of UI screens of the monitoring apparatus used to perform the monitoring apparatus transfer processing.

FIG. 16 illustrates an example of a web page used to perform the monitoring apparatus transfer processing.

### DESCRIPTION OF THE EMBODIMENTS

An exemplary embodiment will be described in detail below with reference to attached drawings.

### <System Configuration>

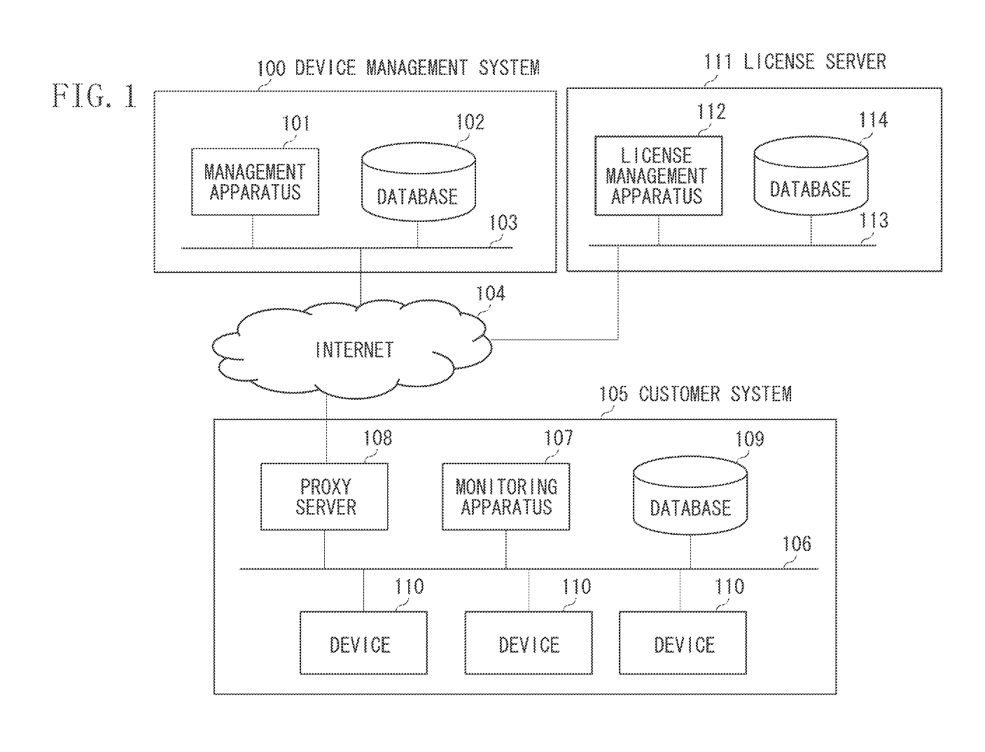

FIG. 1 is a block diagram illustrating an example of the entire configuration of a system according to a first exemplary embodiment.

In FIG. 1, a device management system 100 can manage various types of information about each device installed in a customer environment.

The device management system 100 includes a management apparatus 101 and a database 102. The database 102 stores various data acquired from each device and various types of information required to manage each device. The database 102 and the management apparatus 101 are connected to each other via a local area network (LAN) 103. The LAN 103 is connectable to an internet 104. The database 102 can be physically present in the management apparatus 101. Alternatively, the database 102 can be present at another place that is accessible from the management apparatus 101 via the internet 104.

The management apparatus 101 can provide a web page enabling a user to browse the information stored in the database 102 or processed (or modified) information. The contents that can be browsed via the web page are substantially limited for each authority, according to user authentication. Further, a user can be allowed to change a part of the data stored in the database 102 via the web page. The management apparatus 101 provides a function of enabling a user having specific authority to register various types of information in the database 102 for each customer via the web page. The information that can be registered in this case includes information about a management target device 110 and information about a monitoring apparatus 107 that transmits and receives information to and from the device 110. Further, the management apparatus 101 can obtain an input relating to replacement (transfer) of the monitoring apparatus and can download, via the web page, a software installer capable of causing a device to operate as a monitoring apparatus.

In a customer system 105, the monitoring apparatus 107 can manage each device 110 connected to the LAN 106. The monitoring apparatus 107 can communicate, via a proxy server 108, with the management apparatus 101 connected to the internet 104.

The monitoring apparatus 107 is connectable to the device management system 100 via the network. The monitoring apparatus 107 is an information processing apparatus (e.g., a PC) that is functionally operable as an apparatus capable of monitoring each device 110 in the customer environment (i.e., in the customer system 105). The monitoring apparatus 107 can store various types of information, which includes device information collected from each device 110 and setting value information to be distributed to each device 110, in a database 109. The database 109 is connected to the LAN 106. Alternatively, the database 109 can be present independently in the monitoring apparatus 107. Further, the database 109 can be present at another place that is accessible from the monitoring apparatus 107 via the internet 104. The information acquisition and distribution timing for each device 110 can be managed according to a schedule having been set beforehand by the management apparatus 101.

Further, the monitoring apparatus 107 has a function of automatically searching for an intended device 110 connected to the LAN 106 and transmitting a search result to the management apparatus 101 to cause the management apparatus 101 to register the searched device.

In the present exemplary embodiment, the management apparatus 101 and the monitoring apparatus 107 are physically separated from each other. Alternatively, the monitoring apparatus 107 and the management apparatus 101 can be co-located.

A license server 111 includes a license management apparatus 112 and a database 114. The database 114 stores license information and various types of relevant information required to manage the license information. The database 114 and the license management apparatus 112 are connected to each other via a LAN 113. The LAN 113 is connectable to the internet 104. The database 114 can be physically present in the license management apparatus 112. Further, the database 114 can be present at another place that is accessible from the license management apparatus 112 via the internet 104.

### <Hardware Configuration of Management Apparatus 101 and Monitoring Apparatus 107>

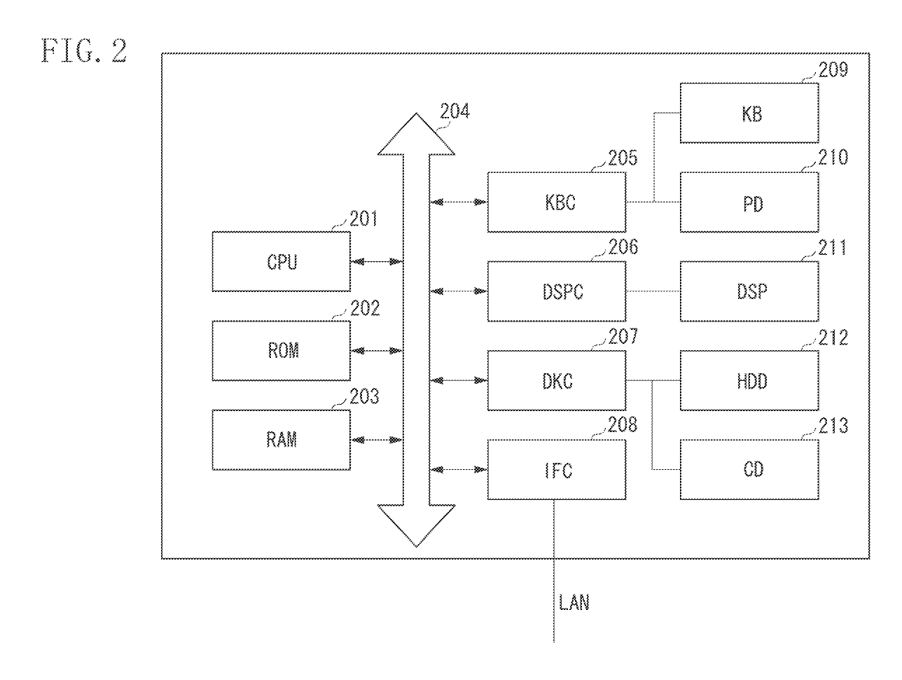

FIG. 2 is a block diagram illustrating an example of the hardware configuration applicable to the management apparatus 101 and the monitoring apparatus 107. The hardware configuration illustrated in the block diagram of FIG. 2 is also applicable to the proxy server 108, the license management apparatus 112, and other back-end information apparatuses (not illustrated).

A central processing unit (CPU) 201 can entirely control various operations of the apparatus. Unless otherwise mentioned in the following description, the CPU 201 is a main hardware component of the apparatus to perform operations thereof. Each software program stored in a hard disk drive (HDD) 212 is a main software component when the apparatus performs a control. Software programs according to the present exemplary embodiment are stored in the hard disk drive (HDD) 212.

A read only memory (ROM) 202 stores a Basic Input/Output System (BIOS) and a boot program. A random access memory (RAM) 203 is functionally operable as a main memory or a work area for the CPU 201. The CPU 201 can read programs from the HDD 212 or the ROM 202 and execute the read programs to perform various controls.

A keyboard controller (KBC) 205 can control instructions input via a keyboard (KB) 209 or a pointing device (PD) 210. A display controller (DSPC) 206 can control contends to be displayed on a display device (DSP) 211.

A disk controller (DKC) 207 can control accesses to a storage device, such as the HDD 212 or a CD-ROM (CD) 213. The boot program, an operating system (OS), a database, software programs, and related data can be stored in the HDD 212 or the CD-ROM (CD) 213. A solid state drive (SSD) or any other appropriate storage device can be provided in addition to or instead of the HDD 212.

An interface controller (IFC) 208 can transmit and receive information to and from another network device via a local area network (LAN). The above-mentioned constituent components 201 to 203 and 205 to 208 are connected to each other via a system bus 204. The operating system (OS) employable in the present exemplary embodiment is, for example, Microsoft Windows (registered trademark), although it is not limited to a specific one.

The software programs according to the present exemplary embodiment can be prepared as a software package stored in an appropriate storage medium (e.g., CD-ROM). In this case, the software programs can be read from the storage medium such as the CD-ROM (CD) 213 illustrated in FIG. 2 and can be saved on the hard disk drive (HDD) 212.

### <Hardware Configuration of Device 110>

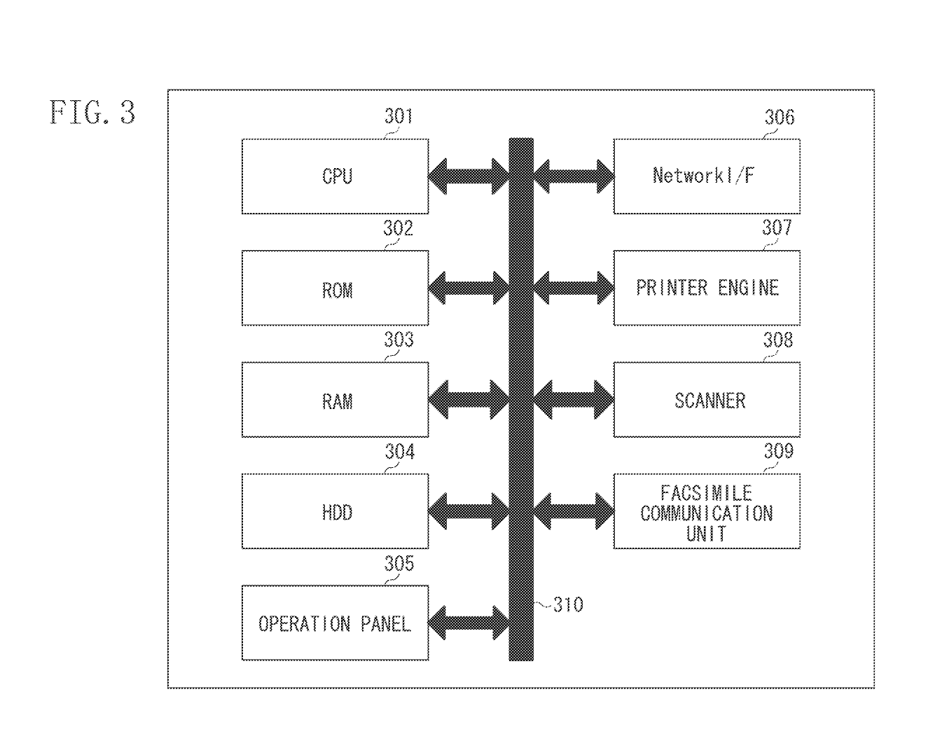

FIG. 3 illustrates a hardware configuration of a multifunction peripheral as an example of the device 110. The multifunction peripheral has a print function, a scan function, and a network communication function, although the device 110 is not limited to the multifunction peripheral. For example, the device 110 can be a printing apparatus (i.e., a printer) or a network camera.

A central processing unit (CPU) 301 can control the entire device 110. A read only memory (ROM) 302 can store print processing programs and font data, which can be executed and processed by the CPU 301. A random access memory (RAM) 303 is used as a work area for the CPU 301 or a reception buffer, or for an image rendering. The CPU 301 can read the programs from the ROM 302 and execute the read programs to perform various controls.

A hard disk drive (HDD) 304 can record setting value information about the device 110 and the like. A solid state drive (SSD) can be provided in addition to or instead of the HDD 304. An operation panel 305 includes various switches and buttons together with a liquid crystal display unit capable of displaying various messages. It is feasible for each user to operate the setting value information on the operation panel 305.

A network interface 306 can connect the device 110 to the network. A printer engine 307 can perform printing on a recording paper. A scanner 308 can read an original document. A facsimile communication unit 309 can transmit and receive facsimile data. The above-mentioned constituent components 301 to 309 are connected to each other via a system bus 310.

### <Software Configuration of Management Apparatus 101>

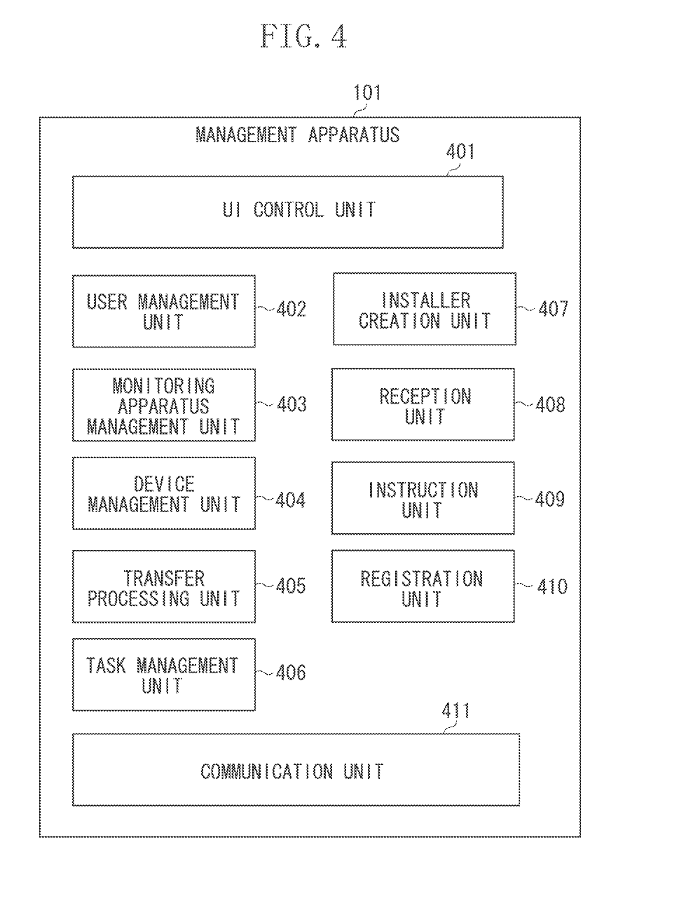

FIG. 4 is a block diagram illustrating an example of the software configuration of the management apparatus 101. To realize constituent components (i.e., UI control unit 401 to communication unit 411) illustrated in FIG. 4, the CPU 201 of the management apparatus 101 reads a related program from the HDD 212 and executes the read program.

A UI control unit 401 can provide a graphical user interface (GUI) of the management apparatus 101. The GUI can be displayed on the display device 211 provided in the management apparatus 101. Alternatively, the UI control unit 401 can configure the GUI as a web application available from other device using HyperText Transfer Protocol (HTTP).

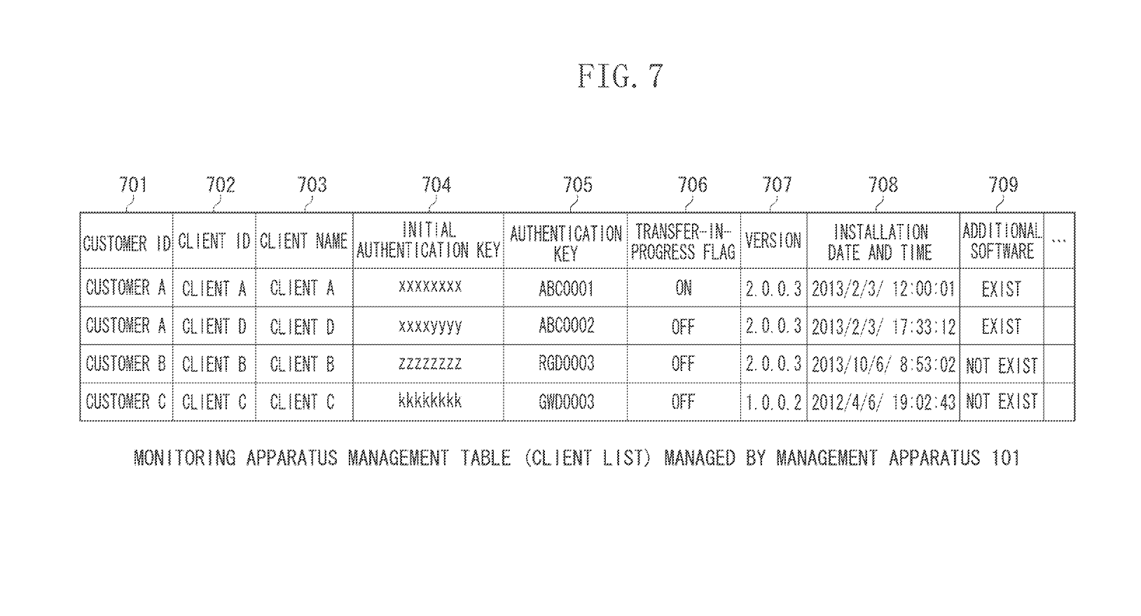

A user management unit 402 can manage customers to be managed by the management apparatus 101. A monitoring apparatus management unit 403 can manage the monitoring apparatus 107 that communicates with the management apparatus 101. The monitoring apparatus management unit 403 is configured to manage each user (i.e., a customer) and the monitoring apparatus 107 while associating them with each other. The monitoring apparatus management unit 403 stores information capable of associating each user with the monitoring apparatus 107 in a monitoring apparatus management table (illustrated in FIG. 7) prepared in the database 102. Further, the monitoring apparatus management unit 403 can manage an authentication key 705 (see FIG. 7) that is required to perform authentication for the management apparatus 101 and the monitoring apparatus 107. The monitoring apparatus management unit 403 stores the authentication key 705 in the monitoring apparatus management table prepared in the database 102.

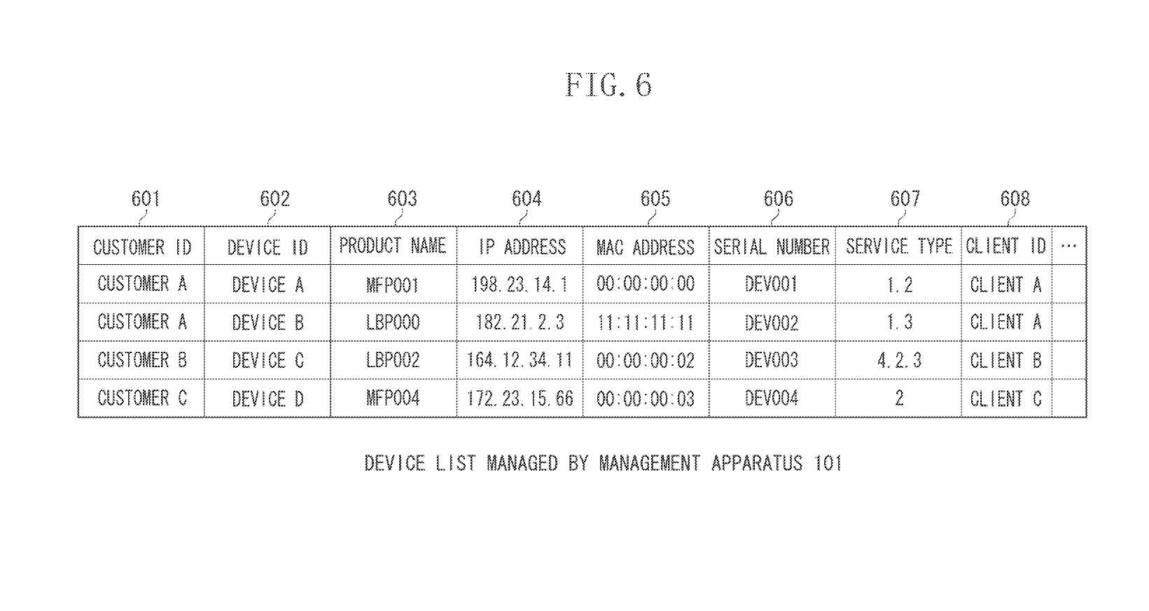

A device management unit 404 can manage devices to be managed by the management apparatus 101. The device management unit 404 stores information about each device registered by a user via the UI control unit 401 and information about each device 110 searched by the monitoring apparatus 107 in a device list (illustrated in FIG. 6) prepared in the database 102. Further, for management in the device list, services that can be provided by the management apparatus 101 are associated with the monitoring apparatus 107 that acquires various types of information about the device required in respective services. The monitoring apparatus 107 selects various types of information to be acquired from each device based on the information associating the service with the monitoring apparatus 107.

A transfer processing unit 405 can control transfer preparation processing for the monitoring apparatus 107 according to a transfer related input performed by a user via the UI control unit 401. Further, the transfer processing unit 405 can control transfer processing according to a transfer instruction from the monitoring apparatus 107 accepted via a communication unit 411.

A task management unit 406 can manage acquisition and distribution of setting value information about each device in unit of task. More specifically, the tasks managed by the task management unit 406 include an acquisition task for acquiring setting value information about each device, a distribution task for distributing setting value information about each device, and a replacement task for replacing setting value information about each device. Each user can register an intended task via the UI control unit 401. The task information registered by a user can be stored in a task list prepared in the database 102 via the communication unit 411.

An installer creation unit 407 can create an installer for the monitoring apparatus 107, which is a software installer capable of causing an information processing apparatus (e.g., a PC) to be functionally operable as the monitoring apparatus 107. The created installer is stored in the database 102. For example, the created installer includes client ID (i.e., identification information uniquely identifying the monitoring apparatus 107) and an initial authentication key 704 (see FIG. 7).

A reception unit 408 can receive various types of information about each device from the monitoring apparatus 107 and information about the monitoring apparatus 107 via the communication unit 411. The reception unit 408 stores the received information in the database 102. Each user can browse and change the information registered in the database 102 via the UI control unit 401.

An instruction unit 409 can output a monitoring apparatus transfer preparation instruction to the monitoring apparatus 107 via the communication unit 411 based on a control of the transfer processing unit 405 according to a transfer related input performed by a user via the UI control unit 401. Further, the instruction unit 409 can distribute various setting information stored in the database 102 to the monitoring apparatus 107.

A registration unit 410 can register information about the monitoring apparatus 107 in the monitoring apparatus management table illustrated in FIG. 7 prepared in the database 102, which can be managed by the monitoring apparatus management unit 403. The registration unit 410 can issue the authentication key 705 (see FIG. 7). If a registration processing request is accepted from the monitoring apparatus 107 via the communication unit 411, the registration unit 410 performs authentication with reference to the client ID and the initial authentication key included in the registration processing request. If initial authentication is established, the registration unit 410 issues the authentication key 705 and stores the issued authentication key 705 in the monitoring apparatus management table via the monitoring apparatus management unit 403. Further, the registration unit 410 transmits the issued authentication key 705, as a response to the registration processing request, to the monitoring apparatus 107. After the above-mentioned operations have been completed, only the authentication using the issued authentication key 705 is permitted to communicate with the monitoring apparatus 107.

### <Software Configuration of the Monitoring Apparatus 107>

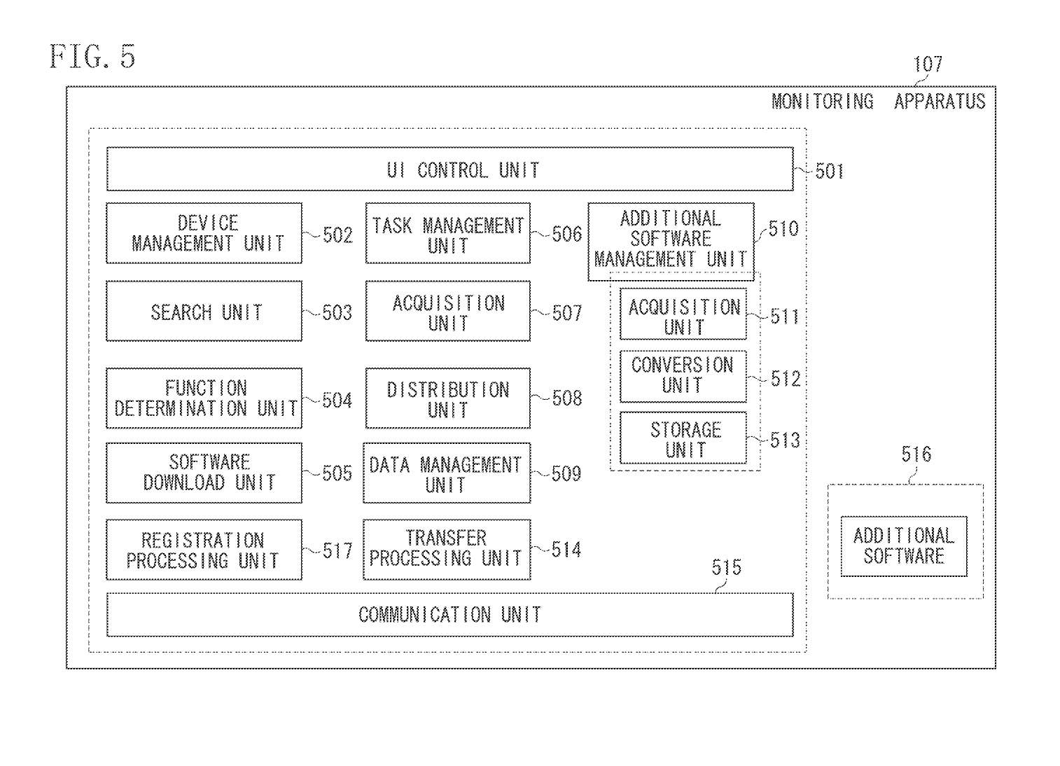

FIG. 5 is a block diagram illustrating an example of the software configuration of the monitoring apparatus 107. To realize constituent components (i.e., UI control unit 501 to registration processing unit 517) illustrated in FIG. 5, the CPU 201 of the monitoring apparatus 107 reads a related program from the HDD 212 and executes the read program.

A UI control unit 501 can provide a graphical user interface (GUI) for the monitoring apparatus 107. The GUI can be displayed on a display device of the operation panel 305. Alternatively, the UI control unit 501 can configure the GUI as a web application, which can be used by another client PC, by using the HTTP.

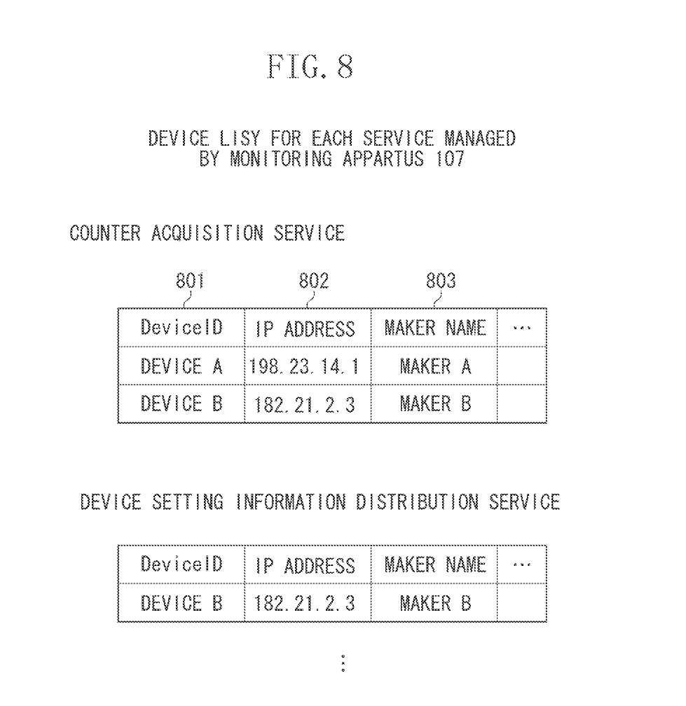

A device management unit 502 can acquire a management target device list illustrated in FIG. 8 for each service from the management apparatus 101 via a communication unit 515 and can store the acquired device list in the database 109. A search unit 503 can search for an intended device 110 connected to the LAN 106, for example, by transmitting a search request packet, such as Service Location Protocol (SLP) or Simple Network Management Protocol (SNMP). Further, the search unit 503 can acquire detailed information (e.g., model name, serial number, performance, state, and MAC address) about each device 110 found in the search via the communication unit 515. The search unit 503 transmits the acquired device information to the management apparatus 101 via the communication unit 515.

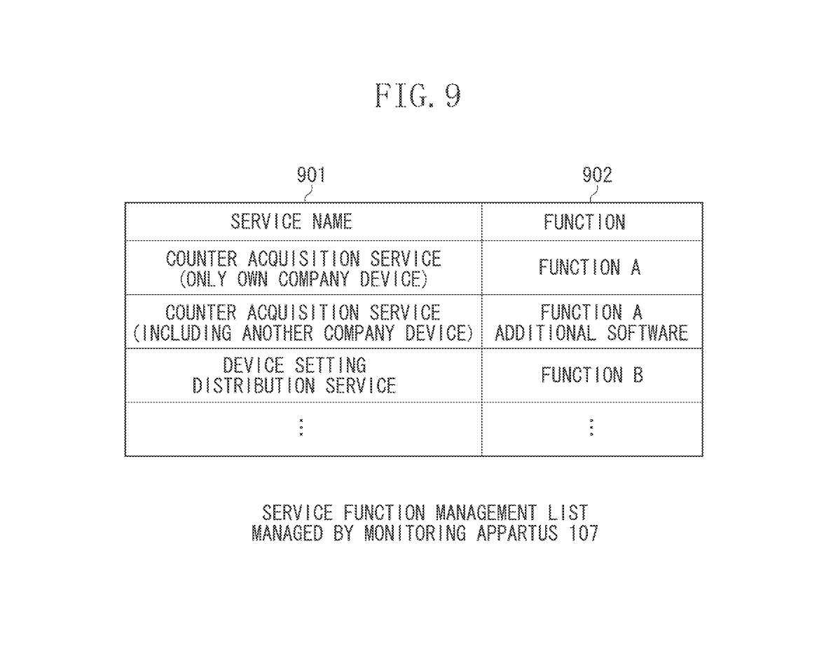

A function determination unit 504 can determine the necessity of additional software based on a service function management list illustrated in FIG. 9 provided therein and the device list managed by the device management unit 502. The function determination unit 504 transmits the determined result with respect to the additional software to the management apparatus 101 via the communication unit 515. In the present exemplary embodiment, the additional software is usable to monitor a device that cannot be monitored by the monitoring apparatus 107 having no additional software installed thereon (e.g., another company device or a specific model device).

A software download unit 505 can determine the presence of software that is required when the monitoring apparatus 107 manages a device. If it is determined that the required software is present, the software download unit 505 acquires the software from the management apparatus 101 via the communication unit 515. Further, the software download unit 505 can acquire license information from the license management apparatus 112 via the communication unit 515 and can install and activate the software using the license information.

A task management unit 506 in the monitoring apparatus 107 can control a task to be managed by the task management unit 406 of the management apparatus 101. For example, if the task to be managed is the acquisition task, the task management unit 506 acquires setting value information about the device 110 via the acquisition unit 507 and transmits the acquired setting value information to the management apparatus 101 via the communication unit 515. Further, if the task to be managed is the distribution task, the task management unit 506 distributes the setting value information about the device 110, which has been received from the management apparatus 101 via the communication unit 515, to the device 110 via a distribution unit 508. Further, the task management unit 506 can manage the task status to perform execution/termination/cancellation of each task.

An acquisition unit 507 can acquire various types of information from each device 110 via the communication unit 515. For example, the information that can be acquired by the acquisition unit 507 includes counter information, device setting value information, status information, and job history. The information to be acquired by the acquisition unit 507 can be determined based on the device list of each service managed by the device management unit 502.

The distribution unit 508 can distribute setting value information received from the management apparatus 101 to the device 110. A data management unit 509 can transmit data acquired from the device 110 to the management apparatus 101 according to a schedule of each service, based on the device list managed by the device management unit 502 and the service function management list managed by the function determination unit 504. Further, the distribution unit 508 can transmit debug log information about the monitoring apparatus 107 to the management apparatus 101.

It is assumed that the web service using HTTP/SOAP realizes the acquisition and distribution of setting value information to be performed by the acquisition unit 507 and the communication unit 515 according to the present exemplary embodiment. However, another communication protocol is usable. In acquiring setting value information from the device 110, it is feasible to configure the monitoring apparatus 107 in such a way as to acquire only predetermined setting value information or acquire setting value information according to the acquisition task received from the management apparatus 101. Similarly, in distributing setting value information to the device 110, it is feasible to configure the monitoring apparatus 107 in such a way as to distribute only predetermined setting value information or distribute setting value information according to the distribution task received from the management apparatus 101.

An additional software management unit 510 can manage additional software. The additional software management unit 510 includes an acquisition unit 511, a conversion unit 512, and a storage unit 513. The additional software management unit 510 can perform a monitoring control for the device 110 that has used the additional software. The acquisition unit 511 can acquire various types of information from each device. The conversion unit 512 can convert information acquired by the acquisition unit 511 into data according to a rule of the additional software management unit 510. The storage unit 513 can store the information acquired by the acquisition unit 511 and the information converted by the conversion unit 512 in the database 109.

Additional software 516 can be internal software owned by a manufacturer of the monitoring apparatus 107 or can be external software provided by a third party.

A transfer processing unit 514 can control transfer processing of the monitoring apparatus 107 according to the transfer preparation instruction instructed from the management apparatus 101 based on the transfer related input performed by a user via the UI control unit 401 or instructed by a user via the UI control unit 501.

A registration processing unit 517 can perform processing for requesting the management apparatus 101 to register the monitoring apparatus 107, via the communication unit 515. The registration processing can be realized by using the client ID and the initial authentication key included in the installer. If the registration processing is successfully completed, the registration processing unit 517 can receive the registered authentication key returned as a result of the registration processing. Subsequently, the authentication key is usable to communicate with the management apparatus 101.

### <Device List Managed by Management Apparatus 101>

FIG. 6 illustrates an example of the device list, which is a list of devices 110 registered in the management apparatus 101.

The device list illustrated in FIG. 6 includes fields of a customer ID 601, a device ID 602, a product name 603, an IP address 604, a MAC address 605, a serial number 606, a service type 607, and a client ID 608. ID information usable to identify each user can be stored in the customer ID 601. ID information usable to identify each device 110 can be stored in the device ID 602. The product name of each device 110 can be stored in the product name 603.

The IP address of each device 110 can be stored in the IP address 604. The MAC address of each device 110 can be stored in the MAC address 605. The serial number of each device 110 can be stored in the serial number 606. ID information representing each service to be provided by the management apparatus 101 can be stored in the service type 607. In a case where a plurality of services is provided, comma-separated ID data can be stored in the service type 607. Although the service type is managed by using ID information in the present exemplary embodiment, any other information is usable.

ID information about the monitoring apparatus 107 that acquires various types of information about the device 110 required to provide various services having been set in the service type 607 is stored in the client ID 608. Although the service type 607 and the client ID 608 are included in the device list according to the present exemplary embodiment, another table is usable to manage the service type and the client ID.

According to the example illustrated in FIG. 6, the device list includes the fields of IP address 604 and MAC address 605. However, the device list can include fields of any other device related information.

### <Monitoring Apparatus Management Table (Client List) Managed by Management Apparatus 101>

FIG. 7 illustrates an example of the monitoring apparatus management table, which is a list of the monitoring apparatuses 107 registered in the management apparatus 101. The monitoring apparatus management table illustrated in FIG. 7 includes fields of a customer ID 701, a client ID 702, a client name 703, an initial authentication key 704, an authentication key 705, a transfer-in-progress flag 706, a version 707, an installation date and time 708, and an additional software 709. ID information usable to identify each user can be stored in the customer ID 701. ID information usable to identify each monitoring apparatus 107 can be stored in the client ID 702. The name of each monitoring apparatus 107 can be stored in the client name 703.

An authentication key usable when the monitoring apparatus 107 initially communicates with the management apparatus 101 can be stored in the initial authentication key 704. The initial authentication key 704 is uniquely associated with the client ID 702. The authentication key usable when the monitoring apparatus 107 communicates with the management apparatus 101 can be stored in the authentication key 705. If the monitoring apparatus 107 and the management apparatus 101 are initially authenticated by using the initial authentication key 704, the management apparatus 101 automatically issues the authentication key 705 and notifies the monitoring apparatus 107 of the issued authentication key 705. After receiving the authentication key 705, the monitoring apparatus 107 performs authentication for the management apparatus 101 by using the authentication key 705.

A flag indicating the presence of a transfer related input of the monitoring apparatus 107 or a transfer instruction can be stored in the transfer-in-progress flag 706. The transfer related input may be performed by a user via the UI control unit 401. The transfer instruction may be transmitted from the monitoring apparatus 107 according to the transfer preparation instruction instructed from the management apparatus 101 based on a transfer related input from a user or can be transmitted from the monitoring apparatus 107 according to a user instruction via the UI control unit 401.

The version information about the monitoring apparatus 107 can be stored in the version 707. Installation date and time of the monitoring apparatus 107 may be stored in the installation date and time 708. The presence of the additional software 516 can be stored in the additional software 709.

According to the example illustrated in FIG. 7, the monitoring apparatus management table includes the fields of version 707 and installation data and time 708. However, the monitoring apparatus management table can include fields of any other information relating to the monitoring apparatus 107.

As illustrated in FIGS. 6 and 7, the device management system 100 can associate the authentication key 705 issued by the registration unit 410, the identification information (i.e., client IDs 701 and 608) about the monitoring apparatus that has issued the authentication key 705, and the customer information (see 601 to 607) about the customer environment in which the monitoring apparatus is installed with each other and can manage the associated information.

### <Device List for Each Service Managed by Monitoring Apparatus 107>

FIG. 8 illustrates an example of the device list for each service, which is a list of devices 110 registered in the monitoring apparatus 107.

The device lists illustrated in FIG. 8 are independently prepared for different target services. According to the example illustrated in FIG. 8, one device list is dedicated to counter acquisition service and another device list is dedicated to device setting information distribution service. The service types according to the present exemplary embodiment include status monitoring service and job history management service (not illustrated) in addition to the counter acquisition service and the device setting information distribution service illustrated in FIG. 8. Further, any other device management related services can be included.

Each device list illustrated in FIG. 8 includes fields of a device ID 801, an IP address 802, and a maker name 803. The ID information usable to identify each device 110 can be stored in the device ID 801. The IP address of each device 110 can be stored in the IP address 802. The maker name of each device 110 can be stored in the maker name 803.

According to the example illustrated in FIG. 8, the device list includes the fields of IP address 802 and maker name 803. However, the device list can further include fields of any other device related information.

### <Service Function Management List Managed by Monitoring Apparatus 107>

FIG. 9 illustrates an example of the service function management list, which is a management list that associates each function of the monitoring apparatus 107 with a necessary module.

The service function management list illustrated in FIG. 9 includes fields of a service name 901 and a function 902. Information indicating each service can be stored in the service name 901. In the present exemplary embodiment, the service name 901 can be used to manage not only service type but also discrimination between own company device and another company device. However, the service name 901 can be used to manage the maker type and other information (e.g., performance level) in association with each service. Information usable to identify a module required to provide the service 901 can be stored in the function 902.

The service function management list according to the present exemplary embodiment is constituted by two types of columns for management. However, any other format is employable for the service function management list if it is feasible to manage required software according to respective conditions. In the present exemplary embodiment, for example, “counter acquisition service” and “another company device” are two conditions to determine the use of the additional software, however, it is not limited thereto.

### <Operations in Monitoring Apparatus Transfer Processing Performed by Management Apparatus 101>

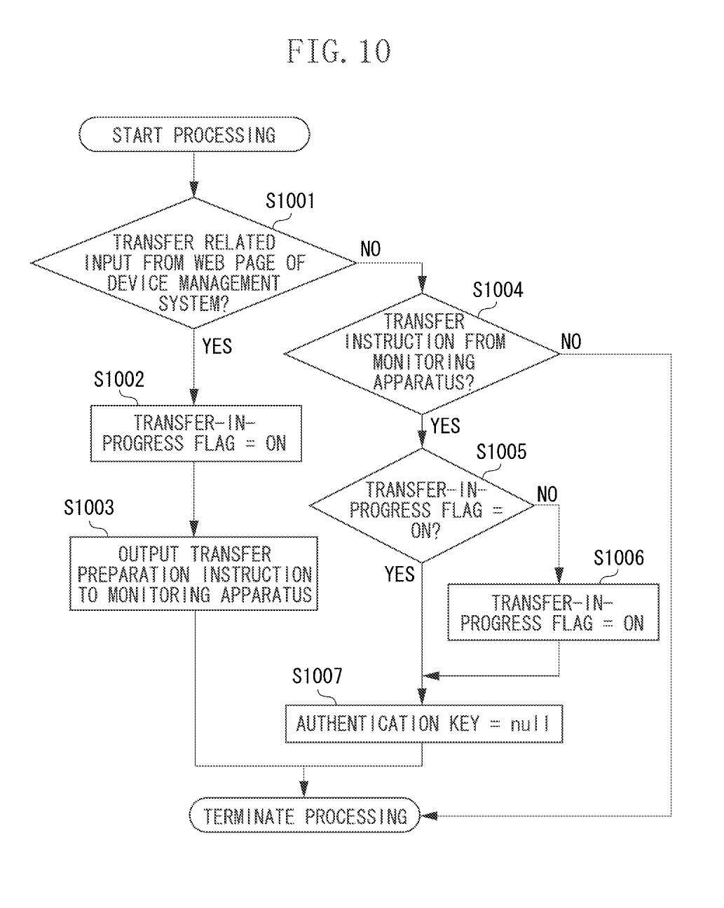

FIG. 10 is a flowchart illustrating an example operation of the management apparatus 101 to be performed in the monitoring apparatus transfer processing according to the present exemplary embodiment. To realize the processing in each step of the flowchart illustrated in FIG. 10, it is assumed that the CPU 201 provided in the management apparatus 101 reads a related control program from a nonvolatile storage device (e.g., the ROM 202 or the HDD 212) and executes the control program according to the present exemplary embodiment. The flowchart illustrated in FIG. 10 includes essential processing according to the present exemplary embodiment and omits other processing not related to the present exemplary embodiment.

The monitoring apparatus management unit 403 starts the processing of the present flowchart illustrated in FIG. 10 in response to an access from the web page of the device management system 100 via the UI control unit 401 or an access from the monitoring apparatus 107 via the communication unit 411.

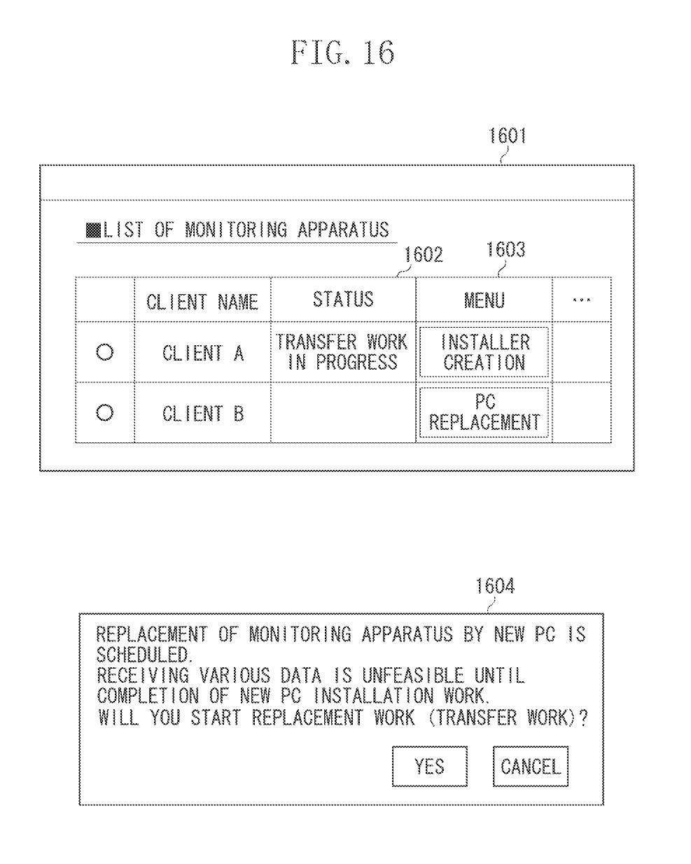

First, in step S1001, the monitoring apparatus management unit 403 determines whether the accepted access is the transfer related input from the web page of the device management system 100. The transfer related input from the web page of the device management system 100 will be described in detail below with reference to FIG. 16.

### <UI Screen Usable in Transfer Processing Performed by Management Apparatus>

FIG. 16 illustrates an example monitoring apparatus management screen 1601 in the web page of the device management system 100.

In FIG. 16, a list of monitoring apparatuses 107, which are managed by the management apparatus 101 in association with the customer ID of a user who is logged on the device management system 100, is displayed on the monitoring apparatus management screen 1601.

The list illustrated in FIG. 16 includes a status 1602 in which the status of each monitoring apparatus 107 can be displayed. For example, messages “download standby” and “transfer work in progress” can be displayed as the status of the monitoring apparatus 107. If a newly installed monitoring apparatus 107 is not yet registered, the message “download standby” is displayed in the status 1602. In the present exemplary embodiment, new installation (i.e., newly installing a monitoring apparatus) is different from installation intended to replace (transfer) the monitoring apparatus as described below. For example, when no data is stored in the installation data and time 708 (see FIG. 7), it is feasible to determine the corresponding monitoring apparatus as a newly installed monitoring apparatus that is not yet registered.

If a target monitoring apparatus accepts a transfer related input (e.g., pressing of a “replacement of PC” button described below), the message “transfer work in progress” is displayed in the status 1602 of the monitoring apparatus 107. In this case, all operations are invalidated if the message “transfer work in progress” is displayed in the status 1602 of the monitoring apparatus 107.

The list illustrated in FIG. 16 includes a menu 1603 in which an operation menu for the monitoring apparatus 107 that can be performed by the management apparatus 101 is displayed. In a case where the message “download standby” or “transfer work in progress” is displayed in the status 1602, an “installer creation” button is displayed in the menu 1603. In a case where other message is displayed in the status 1602, the above-mentioned “replacement of PC” button is displayed in the menu 1603.

If the “installer creation” button is pressed, the installer creation unit 407 of the management apparatus 101 creates the installer of the monitoring apparatus 107 and starts a download operation. If the “replacement of PC” button is pressed, a pop-up screen 1604 is displayed.

The pop-up screen 1604 is a replacement execution confirmation screen that can be used to confirm whether to perform the transfer processing (replacement) of the monitoring apparatus 107. If a “YES” button is pressed on the pop-up displayed replacement execution confirmation screen 1604, the “transfer related input” can be accepted by the management apparatus 101 and an updated message (i.e., “transfer work in progress”) is displayed in the status 1602.

In the present exemplary embodiment, the replacement (transfer) of PC indicates exchange of the PC previously serving as the monitoring apparatus 107 for a new one due to breakdown or deterioration of the PC operating as the monitoring apparatus 107. Further, the “transfer related input” can be performed by an administrator when the PC is replaced (transferred).

The description continues referring back to the flowchart illustrated in FIG. 10.

In the above-mentioned step S1001, if it is determined that the above-mentioned accepted access is the transfer related input from the web page of the device management system 100 (Yes in step S1001), the operation proceeds to step S1002.

In step S1002, under the control of the transfer processing unit 405, the monitoring apparatus management unit 403 changes the transfer-in-progress flag 706 of the monitoring apparatus 107 corresponding to the above-mentioned transfer related input to “ON”. Further, the UI control unit 401 updates the web page (although not illustrated). Next, in step S1003, under the control of the transfer processing unit 405, the instruction unit 409 outputs the transfer preparation instruction to the monitoring apparatus 107 corresponding to the above-mentioned transfer related input and terminates the processing of the flowchart illustrated in FIG. 10. The transfer preparation instruction can be stored in an event queue by the instruction unit 409 and can be outputted as a response to an inquiry from the monitoring apparatus 107. In the present exemplary embodiment, the transfer preparation instruction output from the management apparatus 101 to the monitoring apparatus 107 is a response to the polling from the monitoring apparatus 107. Alternatively, the management apparatus 101 may directly output the transfer preparation instruction to the monitoring apparatus 107.

On the other hand, in the above-mentioned step S1001, if the monitoring apparatus management unit 403 determines that the above-mentioned accepted access is not the transfer related input from the web page of the device management system 100 (NO in step S1001), the operation proceeds to step S1004.

In step S1004, the monitoring apparatus management unit 403 determines whether the above-mentioned accepted access is a transfer instruction from the monitoring apparatus 107. Then, if it is determined that the above-mentioned accepted access is the transfer instruction (Yes in step S1004), the operation proceeds to step S1005.

In step S1005, under the control of the transfer processing unit 405, the monitoring apparatus management unit 403 determines whether the transfer-in-progress flag 706 of the monitoring apparatus 107 corresponding to the above-mentioned transfer instruction is “ON”. Then, if it is determined that the transfer-in-progress flag 706 of the monitoring apparatus 107 corresponding to the above-mentioned transfer instruction is not “ON” (No in step S1005), the operation proceeds to step S1006. In step S1006, under the control of the transfer processing unit 405, the monitoring apparatus management unit 403 changes the transfer-in-progress flag 706 of the monitoring apparatus 107 corresponding to the above-mentioned transfer instruction to “ON”. Subsequently, the operation proceeds to step S1007.

On the other hand, if it is determined that the transfer-in-progress flag 706 of the monitoring apparatus 107 corresponding to the above-mentioned transfer instruction is “ON” (Yes in step S1005), the operation directly proceeds to step S1007.

In step S1007, under the control of the transfer processing unit 405, the monitoring apparatus management unit 403 changes the authentication key 705 of the monitoring apparatus 107 corresponding to the above-mentioned transfer instruction to NULL. Subsequently, the monitoring apparatus management unit 403 terminates the processing of the flowchart illustrated in FIG. 10.

Further, in the above-mentioned step S1004, if it is determined that the above-mentioned accepted access is not the transfer instruction (No in step S1004), the monitoring apparatus management unit 403 performs predetermined processing that corresponds to the above-mentioned accepted access (not illustrated). Then, the monitoring apparatus management unit 403 terminates the processing of the flowchart illustrated in FIG. 10.

### <Flowchart Illustrating Operations in Monitoring Apparatus Replacement Processing Performed by the Monitoring Apparatus 107>

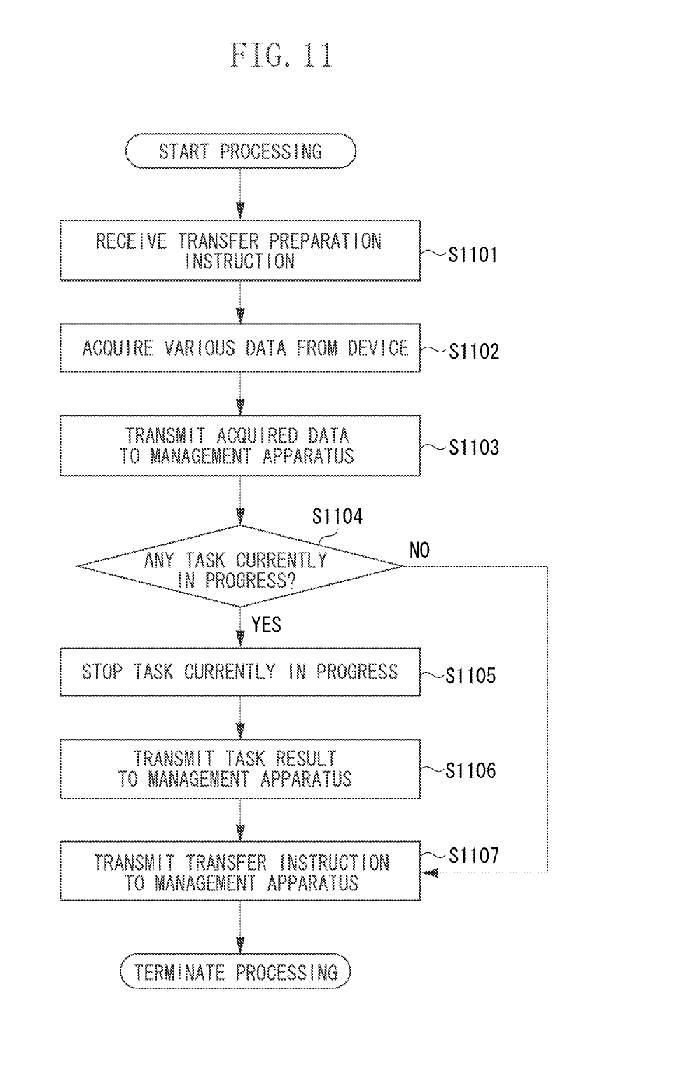

FIG. 11 is a flowchart illustrating an example operation of the monitoring apparatus 107 in the monitoring apparatus transfer processing according to the present exemplary embodiment. To realize the processing in each step of the flowchart illustrated in FIG. 11, it is assumed that the CPU 201 provided in the monitoring apparatus 107 reads a related control program from a nonvolatile storage device (e.g., the ROM 202 or the HDD 212) and executes the control program according to the present exemplary embodiment. The flowchart illustrated in FIG. 11 includes essential processing according to the present exemplary embodiment and omits other processing not related to the present exemplary embodiment. In the present exemplary embodiment, it is assumed that the monitoring apparatus 107 communicates with the management apparatus 101 using the connection to the management apparatus 101 that can be realized by the authentication key 705 issued by the management apparatus 101 (see FIG. 7).

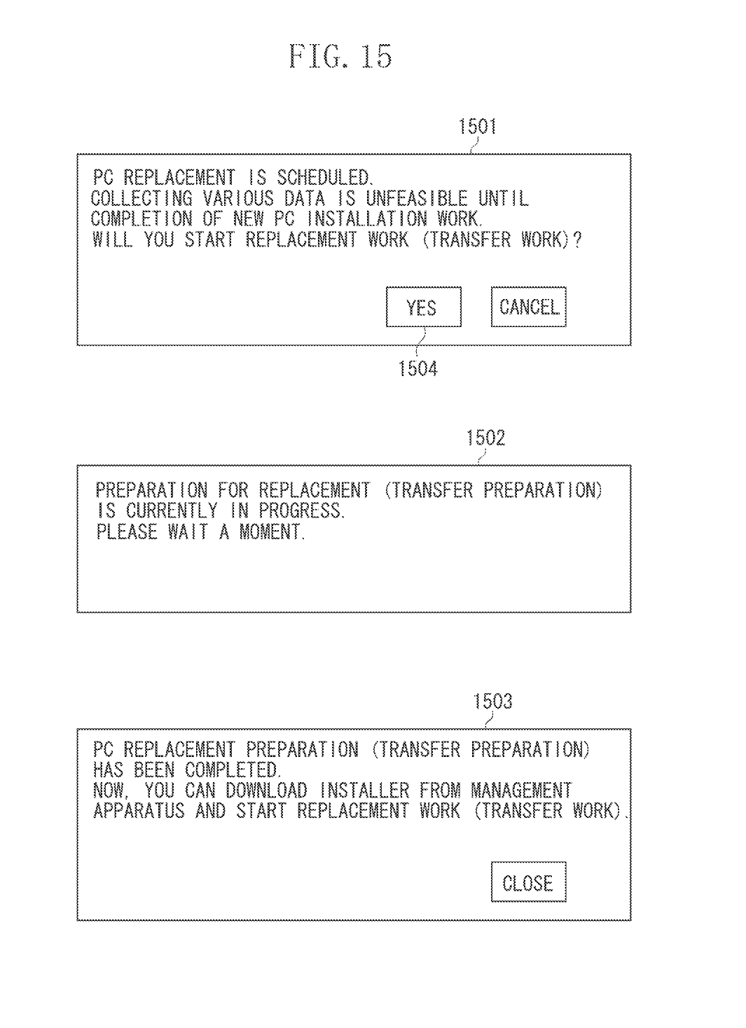

In step S1101, if the transfer processing unit 514 of the monitoring apparatus 107 acquires the monitoring apparatus transfer preparation instruction, the operation proceeds to step S1102. In this case, the transfer preparation instruction can be the one instructed in step S1003 illustrated in FIG. 10 according to the transfer related input from the menu 1603 illustrated in FIG. 16 or can be the one instructed on a transfer execution confirmation screen 1501 illustrated in FIG. 15 via the UI control unit 501. The transfer execution confirmation screen 1501 of the monitoring apparatus 107 will be described in detail below with reference to FIG. 15.

<UI Screen Usable when Monitoring Apparatus 107 Performs Transfer Processing>

FIG. 15 illustrates an example of the screen that can be used in the transfer processing performed by the monitoring apparatus 107. The UI control unit 501 can display the screen illustrated in FIG. 15 on the display unit of the operation panel 305.

The transfer execution confirmation screen 1501 can be pop-up displayed when the transfer related input is received from a customer via the UI control unit 501. If a “YES” button 1504 is pressed by a user, the transfer processing unit 514 accepts the transfer preparation instruction and the UI control unit 501 shifts the screen to a transfer preparation-in-progress screen 1502.

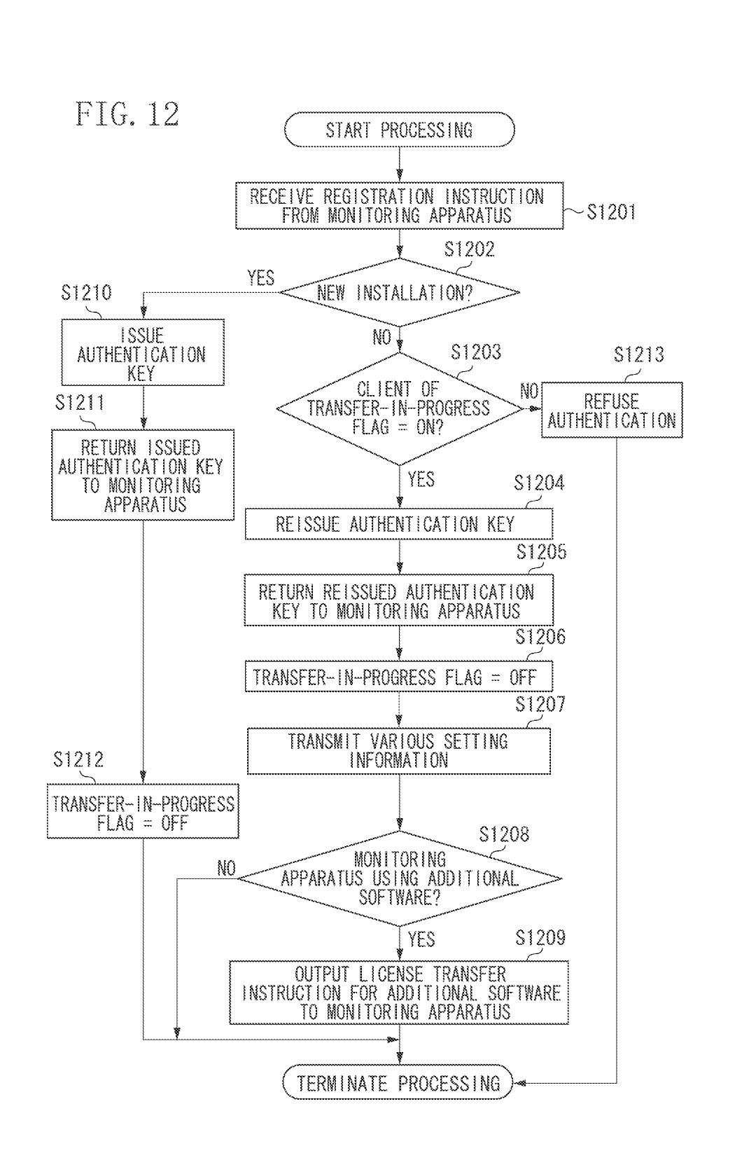

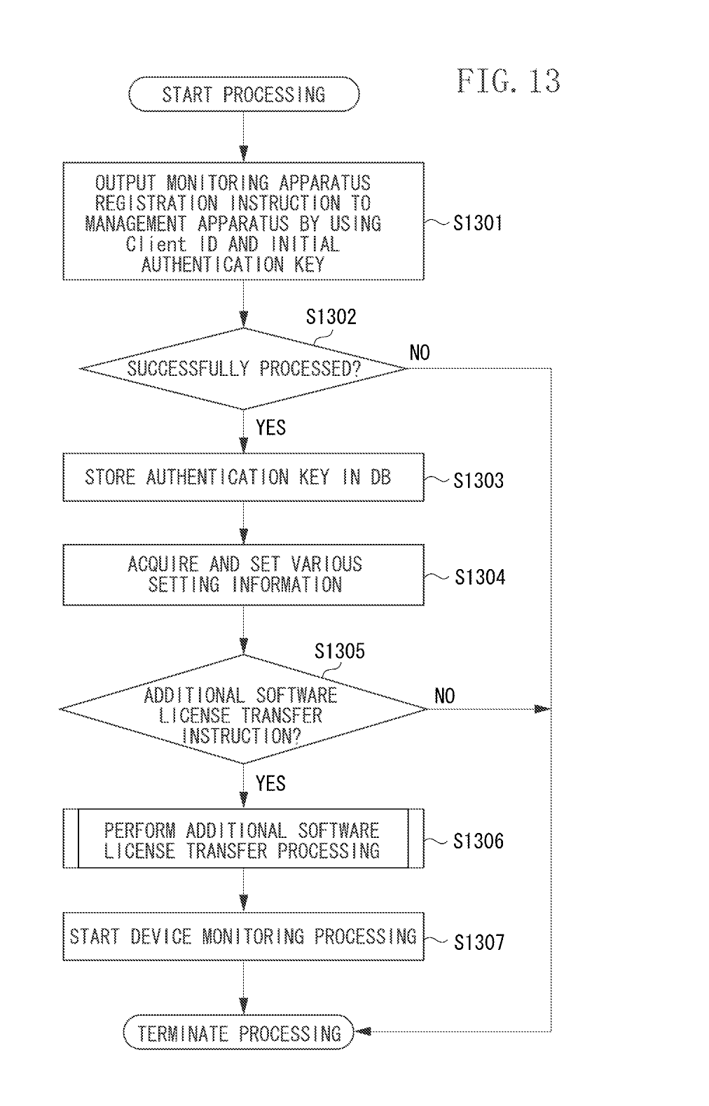

When the transfer preparation-in-progress screen 1502 is displayed, the monitoring apparatus 107 invalidates any operation via the UI screen thereof and performs processing in steps S1102 to S1107 illustrated in FIG. 11. A transfer preparation completion screen 1503 displays a message informing that the processing in steps S1102 to S1107 illustrated in FIG. 11 has been completed, and the transfer work for the monitoring apparatus 107 is now ready to start. More specifically, transfer destination monitoring apparatus registration processing (see FIGS. 12 and 13 described below) can be started at this moment. For example, in starting the transfer destination monitoring apparatus registration processing, a user can press the “installer creation” button illustrated in FIG. 16 and then perform an operation to download and install the created installer.

The description continues referring back to the flowchart illustrated in FIG. 11.

In step S1102, the acquisition unit 507 and the acquisition unit 511 of the additional software management unit 510 acquire information required in each service (e.g., operational information about each device) from the device associated with each service, based on the information in the device list for each service illustrated in FIG. 8. In the present exemplary embodiment, although it is assumed that the above-mentioned information required in each service includes counter information, status information, job history of each device, and debug log of the monitoring apparatus 107, any other information (e.g., the data managed by the monitoring apparatus 107 that should be saved in the management apparatus 101) can be included. For example, it is assumed that the information required in each service includes the device list for each service illustrated in FIG. 8 and the schedule being set by the management apparatus 101 (e.g., the timing to acquire or distribute information from or to the device 110 or the type of information to be acquired or distributed).

Next, in step S1103, the data management unit 509 transmits the information acquired in the above-mentioned step S1102 to the management apparatus 101 via the communication unit 515.

Next, in step S1104, the task management unit 506 determines whether there is a task whose status is “currently in progress” (more specifically, a task currently in progress).

Then, if the task management unit 506 determines that there is a task currently in progress (Yes in step S1104), the operation proceeds to step S1105.

In step S1105, the task management unit 506 performs processing for stopping the task currently in progress. Next, in step S1106, the task management unit 506 transmits a result of the task stop processing performed in the above-mentioned step S1105 to the management apparatus 101 via the communication unit 515. Subsequently, the operation proceeds to step S1007.

Further, in the above-mentioned step S1104, if the task management unit 506 determines that there is not any task currently in progress (No in step S1104), the operation directly proceeds to step S1107.

In step S1107, the transfer processing unit 514 transmits a monitoring apparatus transfer instruction to the management apparatus 101. With this operation, the management apparatus 101 can perform the processing in steps S1005 to S1007 illustrated in FIG. 10. Then, in a step (not illustrated), the UI control unit 501 shifts the screen to the transfer preparation completion screen 1503 illustrated in FIG. 15 and terminates the processing of the flowchart illustrated in FIG. 11.

### <Monitoring Apparatus Registration Processing Performed by Management Apparatus 101>

FIG. 12 is a flowchart illustrating an example operation of the management apparatus 101 in the monitoring apparatus registration processing according to the present exemplary embodiment. To realize the processing in each step of the flowchart illustrated in FIG. 12, it is assumed that the CPU 201 provided in the management apparatus 101 reads a related control program from a nonvolatile storage unit (e.g., the ROM 202 or the HDD 212) and executes the control program according to the present exemplary embodiment. The flowchart illustrated in FIG. 12 includes essential processing according to the present exemplary embodiment and omits other processing not related to the present exemplary embodiment.

In step S1201, if the reception unit 408 of the management apparatus 101 receives a monitoring apparatus registration instruction from the monitoring apparatus 107, the operation proceeds to step S1202. The registration instruction includes a client ID and an initial authentication key.

In step S1202, the registration unit 410 searches the monitoring apparatus management table illustrated in FIG. 7 with reference to the client ID and the initial authentication key included in the registration instruction, and determines whether the registration instruction received in the above-mentioned step S1201 relates to new installation of a monitoring apparatus. For example, if there is not any data stored in the installation data and time 708 (see FIG. 7) of the monitoring apparatus 107 corresponding to the registration instruction received in the above-mentioned step S1201, the registration unit 410 determines that the instructed registration relates to new installation. On the other hand, if there is data stored in the installation data and time 708, the registration unit 410 determines that instructed registration relates to transfer. Any other determination method is usable in step S1202.

Then, if the registration unit 410 determines that the received registration instruction is the registration relating to new installation of a monitoring apparatus (Yes in step S1202), the operation proceeds to step S1210. In step S1210, the registration unit 410 newly issues the authentication key 705. Next, in step S1211, the communication unit 411 transmits the authentication key 705 newly issued in the above-mentioned step S1210, as a response to the registration instruction in the above-mentioned step S1201, to the monitoring apparatus 107. Further, in step S1212, the registration unit 410 changes the transfer-in-progress flag 706 corresponding to the above-mentioned monitoring apparatus 107 to OFF and then terminates the processing of the flowchart illustrated in FIG. 12.

Further, in the above-mentioned step S1202, if the registration unit 410 determines that the registration instruction received in the above-mentioned step S1201 is not the registration relating to new installation of a monitoring apparatus (No in step S1202), the operation proceeds to step S1203.

In step S1203, the registration unit 410 determines whether the transfer-in-progress flag 706 corresponding to the monitoring apparatus 107 having been registration instructed in the above-mentioned step S1201 is “ON”. Then, if the registration unit 410 determines that the transfer-in-progress flag 706 is “ON” (Yes in step S1203), the operation proceeds to step S1204.

In step S1204, the registration unit 410 reissues the authentication key 705. In this case, it is assumed that the authentication key reissued by the registration unit 410 is different from the previously issued authentication key. Therefore, the authentication key issued for a transfer destination monitoring apparatus is differentiated from the authentication key issued for a transfer source monitoring apparatus. In other words, authentication for a transfer source monitoring apparatus becomes unfeasible. For example, even when the registration instruction is received from a transfer destination monitoring apparatus e.g., in the above-mentioned step S1201 due to malfunction (e.g., crash or breakdown) of a transfer source monitoring apparatus or an error by an administrator in a work procedure before the monitoring apparatus 107 performs the transfer processing illustrated in FIG. 11 and the transfer instruction is outputted (i.e., before the management apparatus 101 receives the transfer instruction), it is feasible to invalidate the authentication key having been used for the connection to a transfer source monitoring apparatus by reissuing the authentication key.

Next, in step S1205, the communication unit 411 transmits the authentication key 705 reissued in the above-mentioned step S1204, as a response to the registration instruction in the above-mentioned step S1201, to the monitoring apparatus 107. Further, in step S1206, the registration unit 410 changes the transfer-in-progress flag 706 corresponding to the monitoring apparatus 107 to OFF. Then, the operation proceeds to step S1207.

In step S1207, if the connection from the monitoring apparatus 107 that has transmitted the authentication key reissued in the above-mentioned step S1206 is established by using the authentication key, the instruction unit 409 transmits various setting information to the monitoring apparatus 107 via the connection by using the authentication key. The various setting information to be transmitted in this case includes the information required in each service acquired from each device, transmitted from a transfer source monitoring apparatus in step S1103 illustrated in FIG. 11, or the task information transmitted from a transfer source monitoring apparatus in step S1106 (i.e., the information relating to the task for monitoring the device cancelled in step S1105). Although it is assumed that the above-mentioned information required in each service includes counter information, status information, job history of each device, and debug log of the monitoring apparatus 107, any other information (e.g., the data managed by the monitoring apparatus 107 that should be saved in the management apparatus 101 in the above-mentioned step S1103). For example, it is assumed that the information required in each service includes the device list for each service illustrated in FIG. 8 and the schedule being set by the management apparatus 101 (e.g., the timing to acquire or distribute information from or to the device 110 or the type of information to be acquired or distributed).

Next, in step S1208, the registration unit 410 determines whether the monitoring apparatus 107 is a monitoring apparatus that uses the additional software. In the determination processing in step S1208, if the additional software 709 of the monitoring apparatus 107 “exists”, the registration unit 410 determines that the monitoring apparatus 107 uses the additional software. On the other hand, if the additional software 709 does “not exist”, the registration unit 410 determines that the monitoring apparatus 107 does not use the additional software.

Then, if the registration unit 410 determines that the monitoring apparatus 107 uses the additional software (Yes in step S1208), the operation proceeds to step S1209. In step S1209, the instruction unit 409 outputs a license transfer instruction for the additional software 516 to the monitoring apparatus 107. Then, the instruction unit 409 terminates the processing of the flowchart illustrated in FIG. 12.

On the other hand, if the registration unit 410 determines that the monitoring apparatus 107 does not use the additional software (No in step S1208), the registration unit 410 terminates the processing of the flowchart illustrated in FIG. 12.

Further, in the above-mentioned step S1203, if the registration unit 410 determines that the transfer-in-progress flag 706 of the monitoring apparatus 107 having been registration instructed in the above-mentioned step S1201 is not “ON” (No in step S1203), the operation proceeds to step S1213. In step S1213, the registration unit 410 refuses the authentication for the monitoring apparatus 107 and terminates the processing of the flowchart illustrated in FIG. 12.

### <Registration Processing Performed by Monitoring Apparatus 107>

FIG. 13 is a flowchart illustrating an example operation of the monitoring apparatus in the monitoring apparatus registration processing according to the present exemplary embodiment. To realize the processing in each step of the flowchart illustrated in FIG. 13, it is assumed that the CPU 201 provided in the monitoring apparatus 107 reads a related control program from a nonvolatile storage device (e.g., the ROM 202 or the HDD 212) and executes the control program according to the present exemplary embodiment. The flowchart illustrated in FIG. 13 includes essential processing according to the present exemplary embodiment and omits other processing not related to the present exemplary embodiment.

In step S1301, if the installer of the monitoring apparatus 107 installs software capable of causing a PC to operate as a monitoring apparatus on a new PC, the registration processing unit 517 outputs the monitoring apparatus registration instruction to the management apparatus 101 by using the client ID and the initial authentication key. In the present exemplary embodiment, the client ID (identifying the transfer source monitoring apparatus) and the initial authentication key are included in the installer. Although it is assumed that the installer of the monitoring apparatus 107 is downloadable from the web site of the device management system, an appropriate storage medium (e.g., CD-R) is usable to distribute the installer of the monitoring apparatus 107.

Next, in step S1302, the registration processing unit 517 determines whether a result of the registration instruction processing in the above-mentioned step S1301 is “success”. If the authentication key has been returned as a response to the registration instruction in the above-mentioned step S1301, it is assumed that the registration processing unit 517 determines that the registration instruction processing has been successfully completed. On the other hand, if the authentication key has not been returned as a response to the above-mentioned registration instruction, it is assumed that the registration processing unit 517 determines that the registration instruction processing has been failed.

Then, if the registration processing unit 517 determines that the above-mentioned registration instruction processing has been successfully completed (Yes in step S1302), the operation proceeds to step S1303. In step S1303, the registration processing unit 517 stores the authentication key (i.e., the response to the registration instruction in the above-mentioned step S1301) in the database 109.

Next, in step S1304, if the registration processing unit 517 connects to the management apparatus 101 by using the authentication key returned as the response to the above-mentioned registration instruction, the registration processing unit 517 receives various setting information (i.e., the setting information transmitted in step S1207 illustrated in FIG. 12) from the management apparatus 101 transmitted via the connection established by using the authentication key and stores the received setting information in the database 109. With this operation, the information saved from a transfer source monitoring apparatus to the management apparatus 101 can be set in a transfer destination monitoring apparatus.

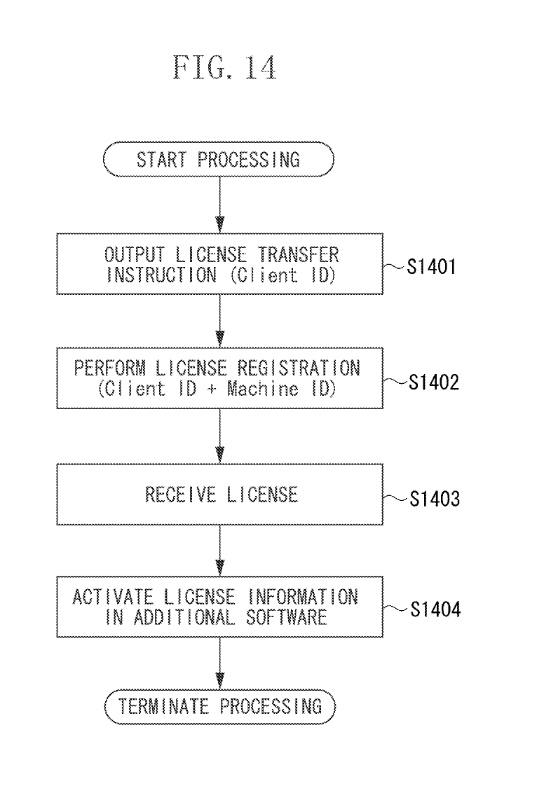

Next, in step S1305, the transfer processing unit 514 determines whether the license transfer instruction for the additional software 516 (i.e., the instruction in step S1209 illustrated in FIG. 12) is received from the management apparatus 101. Then, if the transfer processing unit 514 determines that the additional software license transfer instruction has been received (Yes in step S1305), the operation proceeds to step S1306. In step S1306, the transfer processing unit 514 performs additional software license transfer processing (as described in detail below with reference to FIG. 14). Subsequently, the operation proceeds to step S1307.

On the other hand, in the above-mentioned step S1305, if the transfer processing unit 514 determines that there is not any additional software license transfer instruction (No in step S1305), the operation directly proceeds to step S1307. In step S1307, the transfer processing unit 514 instructs the task management unit 506 to restart the device monitoring processing. Through the above-mentioned processing, the transfer of the monitoring apparatus 107 is completed and the device monitoring processing can be restarted. In this case, the task management unit 506 restarts the device monitoring processing based on the above-mentioned various setting information received in the step S1304. Therefore, it is unnecessary for the administrator to perform the setting again. The administrator's burden in the transfer work can be reduced. Further, information about each task interrupted by the transfer work is included in the above-mentioned various setting information. A transfer destination monitoring apparatus can restart the interrupted task. Therefore, the missing of monitoring data during the transfer work can be prevented.

In the present exemplary embodiment, it is assumed that the device monitoring processing can be restarted in the above-mentioned step S1307 even in a case where the above-mentioned additional software license transfer processing in step S1306 has been failed. In this case, it is assumed that the monitoring apparatus 107 performs only the monitoring processing that can be realized by the basic software without performing any monitoring processing for a specific device (e.g., another company device) that can be realized by the function of the additional software 516.

In the above-mentioned step S1302, if the registration processing unit 517 determines that the registration instruction processing has been failed (No in step S1302), the monitoring apparatus 107 terminates the processing of the flowchart illustrated in FIG. 13 while displaying a failure message on the display device 211 of the monitoring apparatus 107.

### <Additional Software License Transfer Processing Performed by Monitoring Apparatus 107>

FIG. 14 is a flowchart illustrating an example of operations in the additional software license transfer processing that can be performed by the monitoring apparatus 107 according to the present exemplary embodiment. To realize the processing in each step of the flowchart illustrated in FIG. 14, it is assumed that the CPU 201 provided in the monitoring apparatus 107 reads a related control program from a nonvolatile storage device (e.g., the ROM 202 or the HDD 212) and executes the control program according to the present exemplary embodiment. The flowchart illustrated in FIG. 14 includes essential processing according to the present exemplary embodiment and omits other processing not related to the present exemplary embodiment.

In step S1401, the transfer processing unit 514 outputs the license transfer instruction to the license management apparatus 112. The client ID used in the registration instruction in step S1301 illustrated in FIG. 13 (i.e., the client ID identifying the transfer source monitoring apparatus) is included in the license transfer instruction. Therefore, according to the license transfer instruction, the license management apparatus 112 invalidates the license of the additional software managed in association with the client ID included in the license transfer instruction. Through the above-mentioned processing, the license of the additional software associated with a transfer source monitoring apparatus can be invalidated.

Next, in step S1402, the transfer processing unit 514 outputs a license registration instruction to the license management apparatus 112. Client ID and machine ID corresponding to the monitoring apparatus 107 are included in the license registration instruction. The machine ID can be any information (e.g., MAC address) usable to identify the PC serving as the monitoring apparatus 107. In response to the above-mentioned license registration instruction, the license management apparatus 112 registers a license for the additional software with reference to the client ID and the machine ID included in the license registration instruction. Then, the license management apparatus 112 transmits the registered license information, as a response to the above-mentioned license registration instruction, to the monitoring apparatus 107.

Next, in step S1403, the communication unit 515 receives the license information about the additional software 516 from the license management apparatus 112. Next, in step S1404, the additional software management unit 510 activates the additional software license information received in the above-mentioned step S1403 in the additional software 516 and terminates the processing of the flowchart illustrated in FIG. 14.

Although not illustrated in FIG. 14s, if the above-mentioned license information has not been received in the step 1403 or if the above-mentioned activation has been failed in step S1404, the monitoring apparatus 107 determines that the additional license transfer processing has been failed and terminates the processing of the flowchart illustrated in FIG. 14 while displaying a failure message on the display device 211 of the monitoring apparatus 107.

As mentioned above, when the replacement of the PC serving as the monitoring apparatus 107 is performed or when the program of the monitoring apparatus is transferred to another PC, the system according to the present exemplary embodiment can easily and safely transfer monitoring conditions and authentication information relating to the device management system 100. More specifically, it becomes feasible to reduce the administrator's burden in the transfer work of the monitoring apparatus 107. The transfer work can be safely accomplished. Further, information about each task interrupted by the transfer work can be transferred to a transfer destination monitoring apparatus. Therefore, the missing of monitoring data during the transfer work can be prevented.

### OTHER EMBODIMENTS

Additional embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-139963, filed Jul. 7, 2014, which is hereby incorporated by reference herein in its entirety.

What is claimed is:

1. A system including a management system and a monitoring apparatus that is connectable to the management system via a network and can monitor a device in a customer environment,
a first information processing apparatus that is operating as the monitoring apparatus comprising:
a connection unit configured to perform a connection with the management system, using an authentication key issued by the management system;
a control unit configured to control cancellation of a task for monitoring the device and acquisition of operational information from the device according to a transfer related input by a user;
a first transmission unit configured to transmit task information relating to the cancelled task and the acquired operational information to the management system using the connection by the connection unit; and
a second transmission unit configured to transmit a transfer instruction to the management system, using the connection by the connection unit, after the transmission by the first transmission unit,
the management system comprising:
an issuance unit configured to issue the authentication key to be used to establish the connection to the monitoring apparatus;
a management unit configured to manage the authentication key, identification information about the monitoring apparatus for which the authentication key has been issued, and customer information relating to the customer environment in which the monitoring apparatus is installed while associating the information to be managed with each other;
a reception unit configured to receive the task information and the operational information from the first information processing apparatus; and
an invalidation unit configured to invalidate the authentication key managed by the management unit and used in the connection to the first information processing apparatus according to the transfer instruction from the first information processing apparatus,
wherein the management system is further connectable to a second information processing apparatus that is operable as the monitoring apparatus via the network, and
wherein the issuance unit is configured to issue a new authentication key, which is different from the authentication key issued for the first information processing apparatus, for the second information processing apparatus, in response to a request from the second information processing apparatus based on the identification information about the monitoring apparatus having served as the first information processing apparatus such that the second information processing apparatus is newly registered as a monitoring apparatus.

2. The system according to claim 1, wherein the transfer related input can be performed via a user interface provided by the first information processing apparatus or the management system.

3. The system according to claim 1, wherein the second information processing apparatus acquires an installer of software required for operating as the monitoring apparatus from the management system with reference to the customer information relating to the customer environment, and the acquired installer includes the identification information about the monitoring apparatus to be used in the request.

4. The system according to claim 1, wherein the management system transmits the task information and the operational information, received by the reception unit from the first information processing apparatus, to the second information processing apparatus via the connection established using the new authentication key.

5. The system according to claim 1, wherein the invalidation unit invalidates the authentication key used in the connection to the first information processing apparatus if the request is received from the second information processing apparatus based on the identification information about the monitoring apparatus before receiving the transfer instruction from the first information processing apparatus.

6. The system according to claim 1,
wherein the management system determines whether to use additional software based on information managed by the management unit in association with the identification information about the monitoring apparatus serving as the second information processing apparatus, and transmits a license transfer instruction for the additional software to the second information processing apparatus if the management system determines to use the additional software, and
wherein the second information processing apparatus includes a license transfer unit configured to request a license management apparatus that manages the license of the additional software to transfer the license of the additional software from the first information processing apparatus to the second information processing apparatus, based on the license transfer instruction for the additional software received from the management system.

7. The system according to claim 6, wherein the license transfer unit is configured to transmit the identification information about the monitoring apparatus having served as the first information processing apparatus and the identification information about the second information processing apparatus to the license management apparatus, and is configured to acquire a license for the additional software from the license management apparatus.

8. The system according to claim 6, wherein the additional software is for monitoring a device that cannot be monitored by a monitoring apparatus in which the additional software is not installed.

9. A method for controlling a system that includes a management system and a monitoring apparatus that is connectable to the management system via a network and can monitor a device in a customer environment, the method comprising:
issuing, at the management system, the authentication key to be used to establish the connection to the monitoring apparatus,
associating, at the management system, with each other the authentication key, identification information about the monitoring apparatus for which the authentication key has been issued, and customer information relating to the customer environment in which the monitoring apparatus is installed, and managing the associated information,
performing, at a first information processing apparatus that is operating as the monitoring apparatus, a connection with the management system, using the authentication key issued by the management system,
controlling, at the first information processing apparatus, cancellation of a task for monitoring the device and acquisition of operational information from the device according to a transfer related input by a user,
performing, at the first information processing apparatus, first transmission processing for transmitting task information relating to the cancelled task and the acquired operational information to the management system using the connection
performing, at the first information processing apparatus, second transmission processing for transmitting a transfer instruction to the management system, using the connection, after the first transmission processing,
receiving, at the management system, the task information and the operational information from the first information processing apparatus
invalidating, at the management system, the authentication key managed and used in the connection to the first information processing apparatus according to the transfer instruction from the first information processing apparatus,
requesting, at a second information processing apparatus that is operable as the monitoring apparatus, the management system to newly register as a monitoring apparatus, with reference to identification information about the monitoring apparatus serving as the first information processing apparatus, and
further issuing, at the management system, a new authentication key, which is different from the authentication key issued for the first information processing apparatus, for the second information processing apparatus, in response to the request from the second information processing apparatus using the identification information about the monitoring apparatus.
